(19) United States
(12) Patent Application Publication
(10) Pub. No.: US 2025/0245720 A1
(43) Pub. Date: Jul. 31, 2025

(54) SYSTEM AND METHOD FOR CONTROLLING PRODUCT RECOMMENDATIONS

(71) Applicant: Walmart Apollo, LLC, Bentonville, AR (US)

(72) Inventors: Shreyas Saiprasad Jadhav, San Francisco, CA (US); Divya Chaganti, San Jose, CA (US); Yue Xu, San Francisco, CA (US); Sinduja Subramaniam, Sunnyvale, CA (US); Hyun Duk Cho, San Francisco, CA (US); Sushant Kumar, San Jose, CA (US); Kannan Achan, Saratoga, CA (US)

(21) Appl. No.: 18/427,727

(22) Filed: Jan. 30, 2024

(51) Int. Cl. G06Q 30/0601

(52) U.S. Cl. CPC G06Q 30/0631

(57) ABSTRACT

System and methods for controlling product recommendations are disclosed. In some embodiments, a disclosed method includes: storing, in a database, historical customer data associated with a plurality of customers, generating, based on the historical customer data, journey data associated with the customer, determining, based on real-time interaction data, that the customer is interacting with a first product associated with a first category, and generating a cross-pollinating intent score based on the journey data and the real-time interaction data.

### TECHNICAL FIELD

This application relates generally to managing retail products and, more particularly, to systems and methods for controlling product recommendations.

### BACKGROUND

Retailers are consistently presenting customers with products to increase overall revenue. Retailers may suggest or recommend various products to customers while the customer is browsing on an e-commerce platform. For example, retailers may present products from different categories to entice a customer to purchase an additional product. In presenting additional products to customers, the retailers may be able to increase their gross merchandise value (GMV) per user. However, retailers face difficulties in deciding which products to recommend.

Current methods of recommending products to a customer requires a retailer to recommend various products in various categories. This is inefficient as many products may be irrelevant or not desirable to the customer. Further, the customer may not wish to purchase that product during their current browsing session.

### SUMMARY

The embodiments described herein are directed to systems and methods for controlling product recommendations.

In various embodiments, a system is provided including a database storing historical customer data associated with a plurality of customers, a computing device comprising at least one processor in communication with the database, the computing device being configured to generate, based on the historical customer data, journey data associated with the customer, determine, based on real-time interaction data, that the customer is interacting with a first product associated with a first category, and generate a cross-pollinating intent score based on the journey data and the real-time interaction data.

In some embodiments, the computing device is further configured to: identify, based on the journey data, a plurality of cross-pollinating products, the cross-pollinating products being in a cross-pollinating category different than the first category, generate an affinity score for each of the plurality of cross-pollinating products, prioritize each of the plurality of cross-pollinating products based on their respective affinity scores, and display, on a user interface, based on the prioritization, the plurality of cross-pollinating products in a specific arrangement.

In some embodiments, wherein the affinity score is dependent on one or more of a brand affinity score, a product type affinity score, a price affinity score, and a relevance score.

In some embodiments, wherein the affinity score is dependent the cross-pollinating intent score.

In some embodiments, the affinity score is generated by a machine learning model that is evaluated and refined. The machine learning model undergoes incremental training at a regularly set time frame to cause refinement of the machine learning model.

In some embodiments, the computing device is further configured to generate a comparison between two or more cross-pollinating products, based on the comparison, iteratively manipulate one or more weights associated with the affinity score, and generate an updated affinity score based on the manipulated one or more weights.

In some embodiments, the cross-pollinating intent score is a probability that the customer interacts with a second product associated with a second category different than the first category.

In some embodiments, the system further comprises a user interface configured to display a plurality of cross-pollinating products in a prioritized arrangement.

In some embodiments, the historical customer data includes profile data associated with the journey data.

In various embodiments, a computer-implemented method is disclosed. The computer-implemented method includes storing, in a database, historical customer data associated with a plurality of customers, generating, based on the historical customer data, journey data associated with the customer, determining, based on real-time interaction data, that the customer is interacting with a first product associated with a first category, and generating a cross-pollinating intent score based on the journey data and the real-time interaction data.

In some embodiments, the method further includes identifying, based on the journey data, a plurality of cross-pollinating products, the cross-pollinating products being in a cross-pollinating category different than the first category, generating an affinity score for each of the plurality of cross-pollinating products, prioritizing each of the plurality of cross-pollinating products based on their respective affinity scores, and displaying, on a user interface, based on the prioritization, the plurality of cross-pollinating products in a specific arrangement.

In some embodiments, the affinity score is dependent on one or more of a brand affinity score, a product type affinity score, a price affinity score, and a relevance score.

In some embodiments, the affinity score is dependent the cross-pollinating intent score.

In some embodiments, the affinity score is generated by a machine learning model that is evaluated and refined. The machine learning model undergoes incremental training at a regularly set time frame to cause refinement of the machine learning model.

In some embodiments, the method further includes generating a comparison between two or more cross-pollinating products, based on the comparison, iteratively manipulating one or more weights associated with the affinity score, and generating an updated affinity score based on the manipulated one or more weights.

In some embodiments, the cross-pollinating intent score is a probability that the customer interacts with a second product associated with a second category different than the first category.

In some embodiments, the method further includes displaying, on a user interface, a plurality of cross-pollinating products in a prioritized arrangement.

In various embodiments, a non-transitory computer readable medium having instructions stored thereon is disclosed. The instructions, when executed by at least one processor, cause at least one device to perform operations including: storing, in a database, historical customer data associated with a plurality of customers, generating, based on the historical customer data, journey data associated with the customer, determining, based on real-time interaction data, that the customer is interacting with a first product associated with a first category, and generating a cross-pollinating intent score based on the journey data and the real-time interaction data.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to control product price adjustments, in accordance with some embodiments of the present teaching.

FIG. 2 is a block diagram of a recommendation engine, in accordance with some embodiments of the present teaching.

FIG. 3 is a flow diagram of a system for controlling product recommendations, in accordance with some embodiments of the present teaching.

FIG. 4 is a flow diagram of a recommendation engine of the system for controlling product recommendations of FIG. 3, in accordance with some embodiments of the present teaching.

FIG. 5 is a flow diagram of an exemplary embodiment of use of the recommendation engine of FIG. 4, in accordance with some embodiments of the present teaching.

FIG. 6 is a graphic illustrating a comparison between conventional methodologies and methods utilized by the recommendation engine of FIG. 4, in accordance with some embodiments of the present teaching.

FIG. 7 is a graphic illustrating a comparison between conventional methodologies and methods utilized by the recommendation engine of FIG. 4, in accordance with some embodiments of the present teaching.

FIG. 8 is a flowchart illustrating an exemplary method for controlling product recommendations, in accordance with some embodiments of the present teaching.

FIG. 9 is a flowchart illustrating an exemplary method for controlling product recommendations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for controlling product recommendations. In some embodiments, the systems and methods utilize models (e.g., machine learning models) to determine whether a customer will cross-pollinate between online grocery (OG) and general merchandise, and recommend a product based on the cross-pollination determination. The systems and methods provided herein may be used to recommend products that a customer has a high likelihood of purchasing. For example, the systems and method provided herein may determine that a customer will cross-pollinate and may present to the customer a specific product that the customer has a high likelihood of purchasing. The systems and methods may also provide a user interface for displaying of a plurality of recommended items that are ranked based on the likelihood that the customer will purchase the product.

One goal of the present teaching is to determine whether a customer will cross-pollinate and present different products to the customer based on the determination. In some embodiments, a disclosed system utilizes one or more models to determine whether a customer will cross-pollinate and which products to present to the customer to increase the GMV of the customer. The system can present to the customer a carousel of products that have been specifically arranged based on the likelihood of the customer purchasing the product to increase the overall revenue of the retailers per customer.

In some embodiments, the system allows for the prediction of cross-pollination of customers. The system may include a cross-pollination (XP) engine configured to predict, based on historical data, whether a customer will cross-pollinate between OG and GM. In some embodiments, the XP engine is configured to predict whether a customer will a cross-pollinating transaction within a predetermined amount of time.

In some embodiments, the system includes a user interface to provide product recommendations to the customer. The user interface may also provide a plurality of products in a specific arrangement to the customer. In some embodiments, the system automatically generates the plurality of products in the specific arrangement for display to the user via the user interface. The user may interact with the user interface to select one of the plurality of products for purchase.

Furthermore, in the following, various embodiments are described with respect to methods and systems for controlling product recommendations. In some embodiments, a disclosed method includes: storing, in a database, historical customer data associated with a plurality of customers, generating, based on the historical customer data, journey data associated with the customer, determining, based on real-time interaction data, that the customer is interacting with a first product associated with a first category, and generating a cross-pollinating intent score based on the journey data and the real-time interaction data.

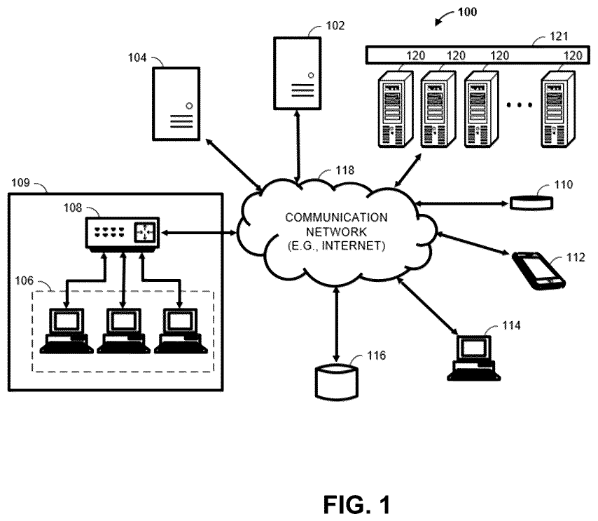

Turning to the drawings, FIG. 1 is a network environment 100 configured to control product recommendations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, recommendation engine 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation engine 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation engine 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation engine 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the recommendation engine 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the recommendation engine 102 over the communication network 118. The workstation(s) 106 may send data to, and receive data from, the recommendation engine 102. For example, the workstation(s) 106 may transmit data identifying items purchased by a customer at the store 109 to the recommendation engine 102.

Although FIG. 1 illustrates three user computing devices 110, 112, 114, the network environment 100 can include any number of user computing devices 110, 112, 114. Similarly, the network environment 100 can include any number of the recommendation engine 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with product recommendations generated by recommendation engine 102. The website may capture these activities as user session data, and transmit the user session data to the recommendation engine 102 over the communication network 118. The website, via the user interface, may also allow the user to view and interact with one or more products recommended to the user by the recommendation engine 102. In some examples, the web server 104 transmits user data to the recommendation engine 102. The user data may include data associated with the user's interaction with the website via the user interface.

In some examples, a user (e.g., a customer) may use one of the user computing devices 110, 112, 114 to view and interact act with one or more products recommended by the recommendation engine 102. The user may use a user interface to view and purchase products via web server 104. The user may, via the web browser or the user interface, view and interact with one or more products. The website may capture at least some of these activities as user data. The web server 104 may transmit the user data to the recommendation engine 102 over the communication network 118, and/or store the user data to the database 116.

In some embodiments, the web server 104 transmits a recommendation request to the recommendation engine 102, e.g. based on a customer's interaction. For example, the recommendation request may be sent based on a user adding one or more items (e.g., anchor item) to their cart on an e-commerce platform. The recommendation request may be sent standalone or together with other related data of the website. In some examples, the recommendation request may carry or indicate user data.

In some examples, the recommendation engine 102 may execute one or more models (e.g., algorithms), such as a mathematical models, machine learning model, deep learning model, statistical model, etc., to generate and implement markdowns for one or more products. The recommendation engine 102 may generate one or more products for purchase by a customer for maximizing GMV associated with the user. In some embodiments, multiple models are executed by the recommendation engine 102 to predict whether a customer will cross-pollinate and to recommend one or more products based on the prediction. For example, the recommendation engine 102 may execute a first model to predict whether a customer will cross-pollinate, may execute a second model to generate recommended products, and may execute a third model to determine a specific arrangement of the recommended products.

The recommendation engine 102 is further operable to communicate with the database 116 over the communication network 118. For example, the recommendation engine 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation engine 102, in some examples, the database 116 can be a local storage device, such as a hard drive, a non-volatile memory, or a USB stick. The recommendation engine 102 may store historical data, business metrics, user data, or data associated with one or more products received from the web server 104 in the database 116. The recommendation engine 102 may receive customer data (e.g., customer historical data). The recommendation engine 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the recommendation engine 102. Upon the model training request, the recommendation engine 102 may retrieve, e.g. from the database 116, historical data associated browsing history (e.g., journey) of a customer. The recommendation engine 102 may train one or more models using the historical data of the customer. The one or more models may be trained to predict whether a customer will cross-pollinate (e.g., purchase a product from OG while shopping for GM or vice versa). The one or more models may be trained to predict whether a customer will cross-pollinate and then recommend products to the customer based on the prediction.

In some embodiments, the outputs from the model may be used to refine and train the model. For example, one or more models may be trained using historical data (e.g., historical transaction data of the customer) and may generate a value (e.g., a binary value) pertaining to whether the customer will cross-pollinate. The generated value may be compared to actual customers with similar historical data to generate a comparison value. The comparison value may be inputted into the one or more models to refine the one or more models to make the one or more models more accurate.

The models, when executed by the recommendation engine 102, allow the recommendation engine 102 to generate predictions (e.g., whether a customer will cross-pollinate) and recommended products based on the predictions. In some examples, the recommendation engine 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the recommendation engine 102 may generate markdown data associated with a markdown plan. The recommendation engine 102 may provide a user interface to allow a user to interact with the recommended products. For example, the user interface may allow a user to view and interact with the recommend products to purchase one or more of the recommended products.

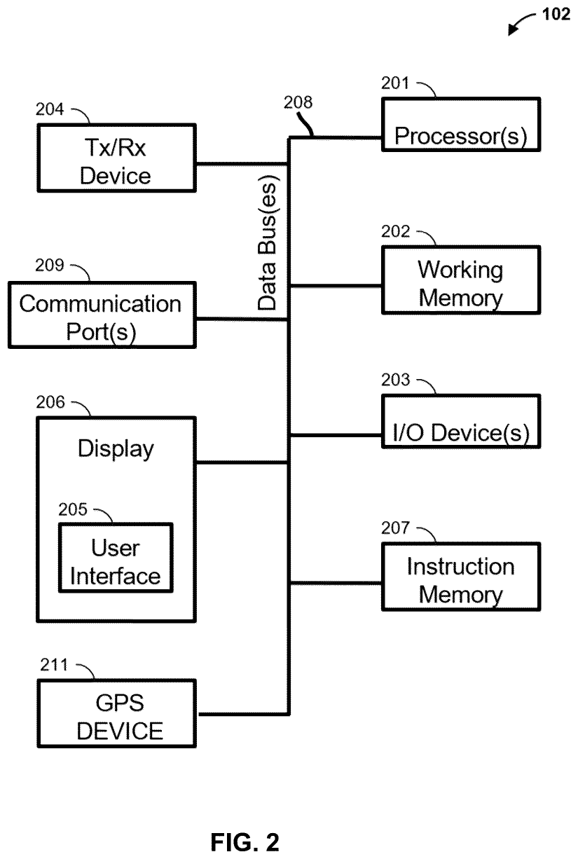

FIG. 2 illustrates a block diagram of a recommendation engine, e.g. the recommendation engine 102 of FIG. 1, in accordance with some embodiments of the present teaching. In some embodiments, each of the recommendation engine 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the recommendation engine 102 can be combined, omitted, and/or replicated. In addition, it will be appreciated that additional elements other than those illustrated in FIG. 2 can be added to the recommendation engine 102.

As shown in FIG. 2, the recommendation engine 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the recommendation engine 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the recommendation engine 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the recommendation engine 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the recommendation engine 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the recommendation engine 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the recommendation engine 102 and/or the web server 104. For example, the user interface 205 can be a user interface for an application of a network environment operator that allows a customer to view and interact with the recommended products generated by the recommendation engine 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the recommendation engine 102 may determine a local geographical area (e.g., town, city, state, etc.) of its position.

In some embodiments, the recommendation engine 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the recommendation engine 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data includes historical data of customers. Further, the training data includes historic sales data (e.g., of the recommended products), typically for one or more years, in association with historic inventory information, historic marketing information, and other such information. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface corresponding to actions by the different recipients interfacing with the respective graphical user interface based on the rendered customized anomaly notification information. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained cross-pollination models, retrained affinity models, retrained product models, retrained recommendation models, and/or other retrained machine learning algorithms that improve performance over time and enhance the prediction of cross-pollination of customers and/or recommended products.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. In some embodiments, the neural network, machine learning models and/or machine learning algorithms may include, but are not limited to, Heuristics, Univariate based techniques, Multivariate, control limit, isolation forest and LOF-ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

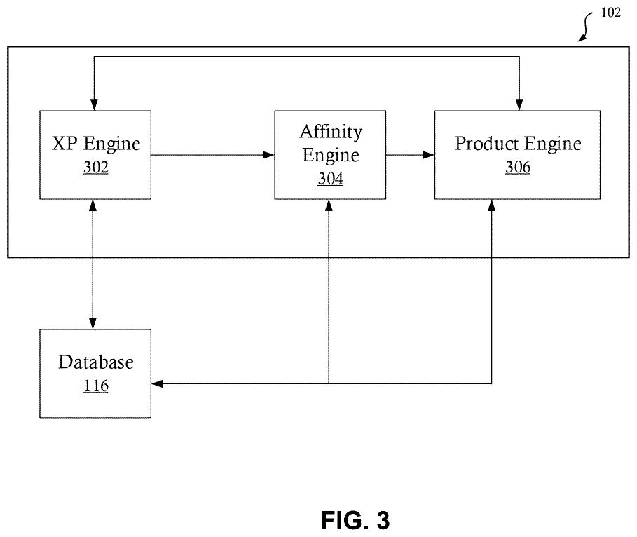

FIG. 3 is a flow diagram of recommendation engine 102, in accordance with some embodiments of the present teaching. As indicated in FIG. 3, recommendation engine 102 may be configured to receive information from a customer through a user interface. The information may include customer historical data. In some embodiments, recommendation engine 102 is configured to generate a prediction, based on the customer historical data, whether the customer will cross-pollinate.

In some embodiments, recommendation engine 102 is configured to provide one or more products to a customer that is predicted to cross-pollinate. For example, recommendation engine 102 may use one or more models (e.g., mathematical optimization models, machine learning models) to determine whether a customer will cross-pollinate and identify products that the customer has a high likelihood of purchasing. In some embodiments, recommendation engine 102 trains one or more models using historical data associated with one or more customers to predict cross-pollination and identify products.

In some embodiments, a customer cross-pollinates when the customer is shopping for products in a specific category and purchases an item from a different category. For example, a customer may cross-pollinate when the customer is online grocery shopping (OG) and purchases a product from general merchandise (GM). A customer that cross-pollinates has an increased likelihood of purchasing a product from a different category to increase the GMV of that customer.

Recommendation engine 102 may include cross-pollination (XP) engine 302, affinity engine 304, and product engine 306. Each of XP engine 302, affinity engine 304, and product engine 306 are in communication with database 116 to transmit and/or receive data from database 116. XP engine 302 may be configured to transmit XP data to affinity engine 304. In some embodiments, affinity engine 304 generates affinity data associated with a customer's affinity towards a specific product. Product engine 306 may be configured to receive the affinity data and present one or more products to a customer for purchase. In some embodiments, product engine 306 is configured to display the one or more products in a specific arrangement.

XP engine 302 may be in communication with each of affinity engine 304 and product engine 306. For example, XP engine 302 may transmit XP intent scores to affinity engine 304. In some embodiments, XP engine 302 receives one or more product recommendations from product engine 306. In some embodiments, XP engine 302 generates one or more journeys associated with the customer and may generate an XP intent score associated with each of the one or more journeys. XP engine 302 may determine that a customer has a high probability of cross-pollinating (e.g., a high XP intent score) from, for example, online grocery to general merchandise associated with one or more of the journeys. In some embodiments, XP engine 302 generates an XP intent score for each journey associated with the customer. For each XP intent score over a predetermined threshold, XP engine 302 may determine that the customer has a likelihood of cross-pollinating to the one or more journeys having an XP intent score over the predetermined threshold. In some embodiments, the XP intent score is from 0 to 1.0 and the predetermined threshold is 0.5.

XP engine 302 may receive one or more cross-pollinating products (e.g., products in a different category) from product engine 306 associated with each journey having a high XP intent score. Product engine 306 may be configured to transmit XP products to XP engine 302 and receive an affinity score from affinity engine 304 indicating an affinity of the customer to the XP products transmitted by product engine 306. In some embodiments, affinity engine 304 is configured to generate an affinity score and also provide a ranking of the XP products for display by product engine 306. Product engine 306 may then present the XP products in a specific arrangement via a user interface based on the affinity score generated by affinity engine 304. In some embodiments, product engine 306 causes a user interface to generate the specific arrangement of the XP products based on the affinity score generated by affinity engine 304.

In some embodiments, XP engine 302 utilizes one or more machine learning models to predict the likelihood of a customer cross-pollinating between distinct product categories (e.g., OG to GM, GM to OG) within a journey.

In some embodiments, different customers are on different shopping journeys while interacting with an e-commerce platform. For example, XP engine 302 may be configured to receive historical customer data from database 116 and generate profile data associated with each customer. The profile data may include one or more journeys (e.g., journey data) associated with each customer. The historical customer data may include browsing history, interaction data (e.g., clicks, views, interactions), recently purchased products, products added to an online cart, etc. In some embodiments, the interaction data includes real-time interactions of the customer with the e-commerce platform.

XP engine 302 may be configured to generate journey data and profile data based on the historical customer data. The profile data may be based off the journey data. XP engine 302 may parse the historical customer data for first customer and identify product data directed to baby care and product data directed to dog toys. XP engine 302 may be configured to aggregate the product data associated with baby care into a first journey associated with a first profile and aggregate the product data into a second journey associated with dog toys into a second profile. The first profile (e.g., new parent) and the second profile (e.g., pet parent) may each be associated with the first customer based on the parsed and aggregated historical customer data.

Profile data associated with a first customer may include a first profile that they are a new parent based on their historical customer data. The profile data may also include a second profile associated with the first customer that the first customer is a pet parent based on their historical customer data. First customer may have one or more profiles based on their historical customer data. In some embodiments, XP engine 302 is configured to parse and aggregate historical customer data to determine similar profiles for each customer. XP engine 302 may parse the historical customer data and aggregate similar products to determine the one or more profiles.

In some embodiments, XP engine 302 is configured to receive historical customer data associated with a plurality of customers from database 116. XP engine 302 may generate profile data and journey data based off the historical customer data. The journey data may be associated with the profile data and may be used to generate profile data for each customer. For example, for a first customer, the journey data may be used to create one or more profiles that is stored as profile data. The historical customer data may include product data associated with recently interacted with products (e.g., products view, products clicked, products added to cart, products purchased, etc.). The product data may be analyzed by XP engine 302 (e.g., parsed and aggregated) to group similar products. XP engine 302 may generate journey data based on the product data and link or map the journey data to the historical customer data. In some embodiments, the journey data is used to generate profile data associated with the customer. A customer may have one or more profiles based on the profile data generated by XP engine 302.

In practice, XP engine 302, based on historical customer data, generates one or more journeys associated with a customer and based on the one or more journeys, generates one or more profiles. In some embodiments, XP engine 302 is configured to predict the likelihood of a customer cross-pollinating based on their profile data (e.g., profiles associated with the customer). XP engine 302 may be configured to generate prediction of a customer's XP (cross-pollination) intent, contextualized within their ongoing shopping journey (e.g., profile data generated based on journey data).

In some embodiments, XP engine 302 is configured to generate a binary value associated with a prediction of whether a customer will cross-pollinate. For example, XP engine 302 may use one or more models to generate a binary value of 0 or 1, 0 indicating the customer will not cross-pollinate and 1 indicating that the customer will cross-pollinate. In some embodiments, XP engine 302 generates the binary value (e.g., prediction) in association with whether the customer will cross-pollinate in a predetermined amount of time (e.g., one week, one month, two months, three months, six months, one year, or between one day and one year). XP engine 302 may be configured to employ one model per customer journey. For example, XP engine 302 may utilize one model for a first journey of a first customer and a second model for a second journey of the first customer.

In some embodiments, XP engine 302 utilizes a model based on:

$$P ( Label = 1 \vert X ) = σ ( {W}_{journey}^{( 1 )} \vert \cdot Concat ( {X}_{interactions} , {X}_{embeddings} ) )$$

Where P (Label=1|X) is the probability of cross-pollination customized for different customer journeys, σ is the sigmoid activation function, W⁽¹⁾_{journey} is the weight matrix for the proposed model for the first customer journey and denotes the concatenation operation, X_{interactions} includes features related to the customer's historical transactions, and X_{embeddings} includes features related to item product type embeddings.

In some embodiment, XP engine 302 outputs an XP intent score for each journey associated with the journey data. The XP intent score may be the probability of cross-pollination for each journey associated with the customer. For example, XP engine 302 may identify one or more journeys from the journey data leading to the generation of one or more profiles (e.g., new parent, pet parent, DIY, busy family, etc.) The XP intent score may be a numerical value defined by the probability (e.g., intent) of the customer cross-pollinating.

In some embodiments, the model utilized by XP engine 302 allows for customization for different journeys per customer. XP engine 302 may utilize analogous models for each distinct customer journey, allowing for personalized predictions across various journeys. XP engine 302 may utilize several types of models, such as one or more different models. In some embodiments, XP engine 302 generates a distinct model for each journey for each customer.

In some embodiments, XP engine 302 is configured to evaluate the models utilized for predicting whether a customer will cross-pollinate to determine the accuracy of the model. XP engine 302 may refine the models based on the evaluation of the models. In some embodiments, XP engine 302 generate an evaluation score (e.g., F1 score) for the models based on precision, recall, accuracy based on the below.

$$Precision : P = \frac{True Positive}{True Positives + False Positives}$$

$$Recall : R = \frac{True Positives}{True Positives + False Negatives}$$

$$Accuracy : A = \frac{True Positives + True Negatives}{Total Instances}$$

$$Evaluation Score : F 1 = 2 \times \frac{P \times R}{P + R}$$

In some embodiments, XP engine 302 is configured to evaluate the model and refine the model based on the evaluation. For example, XP engine 302 may determine that a first set of customers have a high probability of cross-pollinating. XP engine 302 may then receive evaluation data from database 116 that the first set of customers did actually cross-pollinating, thereby affirming the model. In some embodiments, XP engine 302 may receive evaluation data that the first set of customers did not cross-pollinating, thereby requiring refining of the model. XP engine 302 may refine the model to generate a subsequent model and evaluate the subsequent model as described above. XP engine 302 may repeat these steps to generate a model that is accurately predicts customers that will cross-pollinate.

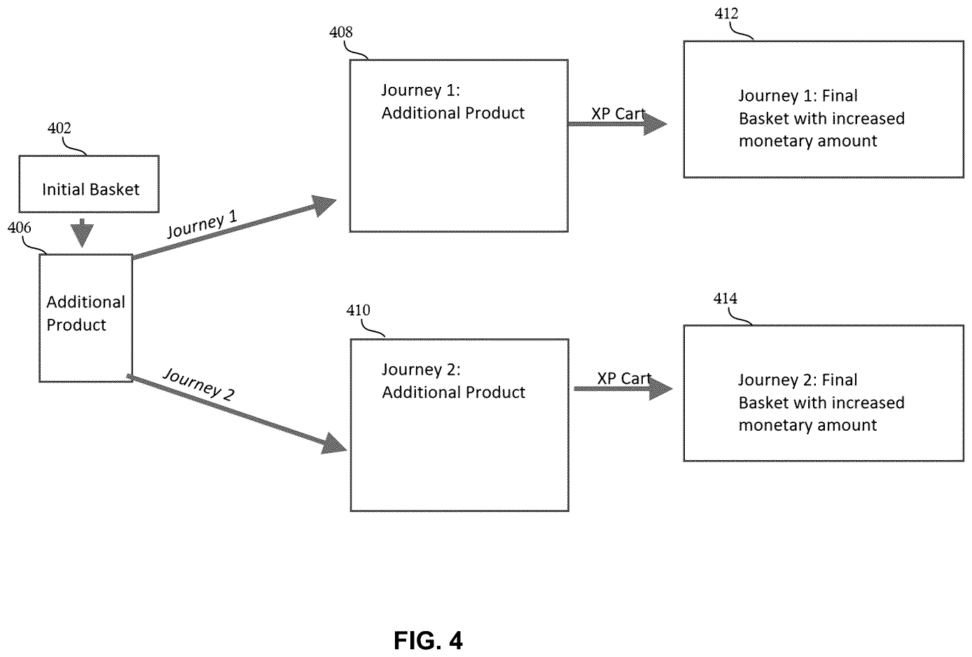

FIG. 4. illustrates an exemplary flow of recommendation engine 102 based on a customer's experience. At 402, a customer may utilize an e-commerce platform to add one or more products to an initial basket. Recommendation engine 102 may analyze the historical customer data associated with the customer and may identify, for example, two journeys based on journey data associated with the customer. Based on the identification of the two journeys, recommendation engine 102 may determine that the customer is likely to cross-pollinate. Based on interaction data, recommendation engine 102 may determine that the customer is browsing for products in a first category. In some embodiments, recommendation engine 102 makes this determination in real-time based on real-time receipt of the interaction data.

Recommendation engine 102 at 406 may recommend an additional product based on the identified journeys. The additional product may be associated with a second category different from the first category (e.g., a cross-pollinating category). In some embodiments, recommendation engine 102 recommends a first additional product for journey 1 and different second additional product for journey 2. The first additional product may be specific to journey 1 and the second additional product may be specific to journey 2. In some embodiments, first additional product and second additional product are identified by recommendation engine 102 as being highly likely to be added to the customer's cart to increase the GMV of the customer.

In some embodiments, one XP engine 302 determines that a customer has a likelihood or high probability (e.g., high XP intent score) of cross-pollinating, XP engine 302 may transmit the XP intent score to affinity engine 304. Affinity engine 304 may be configured to generate an XP affinity score (“affinity score”). The XP affinity score may indicate the affinity of a customer to a specific product based on their XP intent score generated by XP engine 302. The XP intent score may indicate the relationship between the customer for which the XP intent score is associated with and a specific item. Affinity engine 304 may be configured to generate an affinity score for a plurality of items. For example, recommendation engine 102 may identify a plurality of products in a different category than the customer is currently shopping in. The plurality of products may be related to one or more journeys associated with the customer.

XP engine 302 may receive one or more cross pollinating products (e.g., XP products) from product engine 306 that are in different category than the category that the customer is currently shopping/browsing in. Affinity engine 304 may receive the one or more XP products from product engine 306 (e.g., via XP engine 302) along with the XP intent score. Affinity engine 304 may use one or more models to generate an affinity score between the customer and each of the one or more XP products.

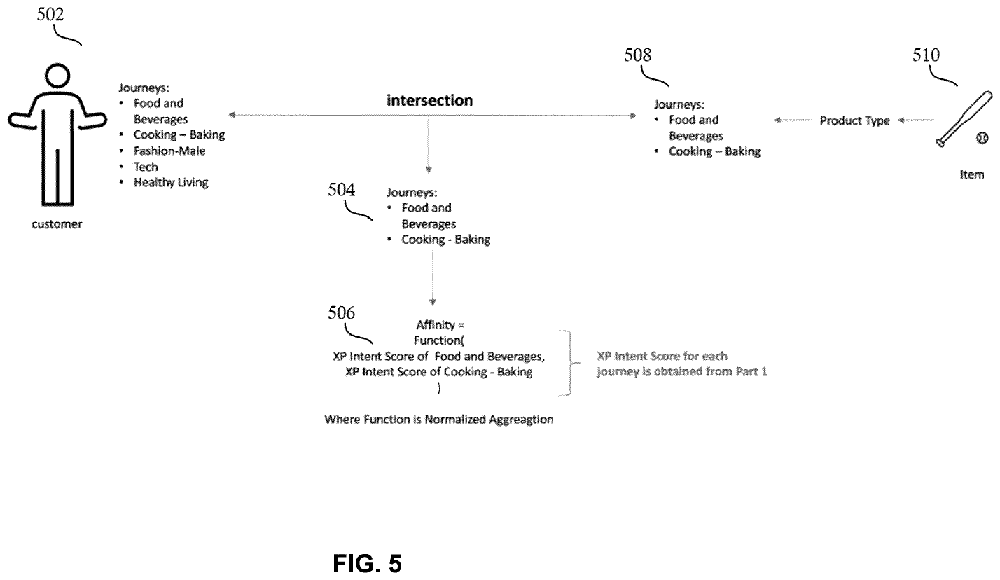

FIG. 5 illustrates an exemplary embodiment of the use of recommendation engine 102 with a customer. At 502, XP engine 302 may generate profile data associated with the customer. The profile data may include journey data associated with one or more journeys In this example, XP engine 302 may generate profile data that includes journey data indicating journeys of “Food and Beverages,” “Cooking-Baking,” “Fashion-Male,” “Tech,” and “Healthy Living.” In some embodiments, product engine 306 transmits to XP engine 302 one or more XP products that are related to one or more these journeys. XP engine 302 may generate an XP intent score for each of the journeys indicating the probability of customer cross-pollinating from, for example, online grocery to general merchandise associated with one of the journeys. XP engine 302 may transmit the XP intent score associated with each journey to affinity engine 304 along with the one or more XP products received from product engine 306. At 504, XP engine may identify one or more journeys with a high XP intent score (e.g., an XP intent score over a predetermine threshold) that indicates that the customer will cross-pollinate from, for example, online grocery to general merchandise associated with one or more of the journeys.

In the example of FIG. 5, XP engine 302 may determine that “Food and Beverages” and “Cooking-Baking” each of a high XP intent score (e.g., an XP intent score over a predetermined threshold) indicating that the customer has a high likelihood of cross-pollinating from a first category (e.g., online grocery) to a second category (e.g., general merchandise) associated with “Food and Beverages” and/or “Cooking-Baking.” Affinity engine 304 may receive from XP engine 302 the XP intent scores for associated with the customer and the journeys of “Food and Beverages” and/or “Cooking-Baking.” At 506, Affinity engine 304 generates an affinity score with one or more XP products associated with “Food and Beverages” and “Cooking-Baking.” In some embodiments, the one or more XP products may be identified by product engine 306 and transmitted to affinity engine 304 via XP engine 302. The affinity score may be dependent on the XP intent score. In some embodiments, affinity engine 304 utilizes one or more models or functions to generate the affinity score with the XP intent score being an input. In some embodiments, the function utilized by affinity engine 304 is normalized aggregation.

At 508, affinity engine 304 may transmit the affinity scores associated with each of the XP products to product engine 306. For example, affinity engine 304 may generate an affinity score for each of the journeys identified as having an XP intent score above the predetermined threshold. In some embodiments, each journey has a plurality of journey products. Affinity engine 304 may generate an affinity score indicating an affinity of the customer to each of the plurality of journey products for each journey. At 510, product engine 306 may identify a product or product type based on the affinity score. In some embodiments, affinity engine 304 aggregates all the XP products from the one or more journeys and prioritize the XP products with the highest affinity score. The prioritization may be sent to product engine 306 for displaying of XP products in a specific arrangement to the customer. In some embodiments, product engine 306 is configured to display, on a user interface, the XP products in a specific arrangement based on the affinity score, as explained in detail below.

In some embodiments, the methods utilized by recommendation engine 102 for displaying XP products to a customer require an anchor item. The XP products may be compared and prioritized relative to the anchor item. In some embodiments, the anchor item is the item or product that the customer is currently interacting with. For example, the anchor item may be an item or product in a first category (e.g., online grocery) and recommendation engine 102 may provide a recommended product that is in a second category (e.g., general merchandise) different than the first category.

In some embodiments, the one or more models employed by affinity engine 304 utilize a relevance score for each product (e.g., each recommended product). In some embodiments, the recommended product is associated with the specific journey of the customer. The relevance score of a product may indicate how relevant that product is to the anchor item. The higher the relevance score, the more the product is associated or relevant to the anchor item. In some embodiments, the relevance score is from 0 to 1.0. The one or more models employed by affinity engine 304 may also utilize various other inputs. For example, one or more models employed by affinity engine 304 may utilize a brand affinity score, a product type affinity, and/or a price affinity score. The brand affinity score may indicate the affinity of the customer towards specific brands. For example, each XP product may have a brand associated with it and based on the historical customer data, affinity engine 304, using one or more models, may determine which brands the customer prefers or has affinity for (e.g., tends to purchase). The price affinity score may indicate the affinity of the customer towards specific price points. For example, each XP product may have a specific price associated with it and based on the historical customer data, affinity engine 304, using one or more models, may determine which price points the customer prefers (e.g., tends to purchase) or stays away from. The product type score may indicate the affinity of the customer towards specific product types. For example, each XP product may be associated with a specific product type and based on the historical customer data, affinity engine 304, using one or more models, may determine which product type the customer prefers or has affinity for (e.g., tends to purchase).

In some embodiments, affinity engine 304 utilizes the XP intent score to generate the affinity score and generate a prioritization of the XP products. Product engine 306 may utilize one or more models to present the prioritization of the XP products to the customer. For example, the one or more models employed by product engine 306 may utilize one or more of the brand affinity score, the price affinity score, the relevance score, affinity score, and the XP intent score to prioritize one or more XP products.

In some embodiment, conventional methods of identifying and providing XP products to a customer solely relied on generating a relevance score based on how relevant the product is to the anchor item. However, the relevance score does not take into account the specific customer (e.g., the XP intent score associated with the customer) or historical customer data.

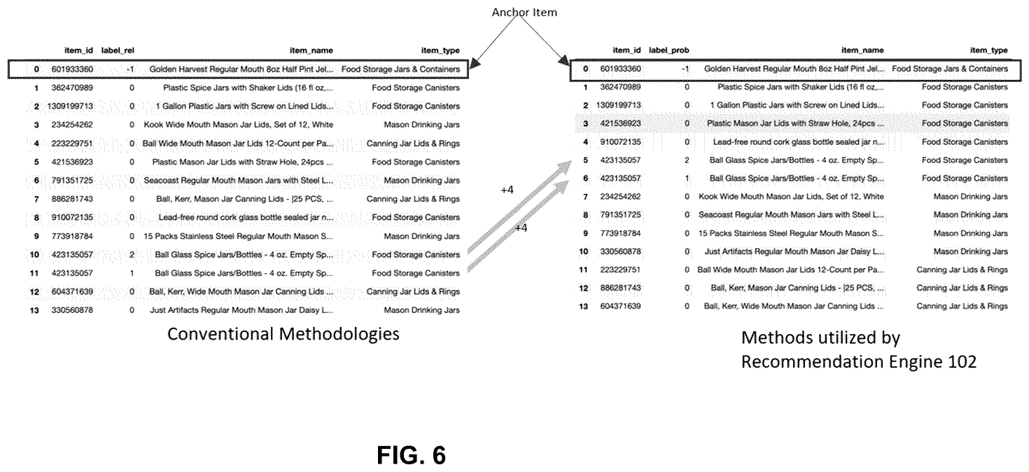

FIG. 6 illustrates a comparison between conventional methods and the methods utilizes by recommendation engine 102 for presenting XP products to a customer. As shown in FIG. 6, using conventional methods of solely relying on a relevance score, the order of XP products presented to customer vary greatly compared to the order of XP products determined by recommendation engine 102. For example, recommendation engine 102 may determine that the customer has a higher affinity towards “Ball Glass Spice Jars/Bottles” and thus may present those higher on a display of XP products to the customer. This ensures that customer quickly sees the XP product they have an affinity for, resulting in the customer purchasing the XP product and increasing the GMV for that customer.

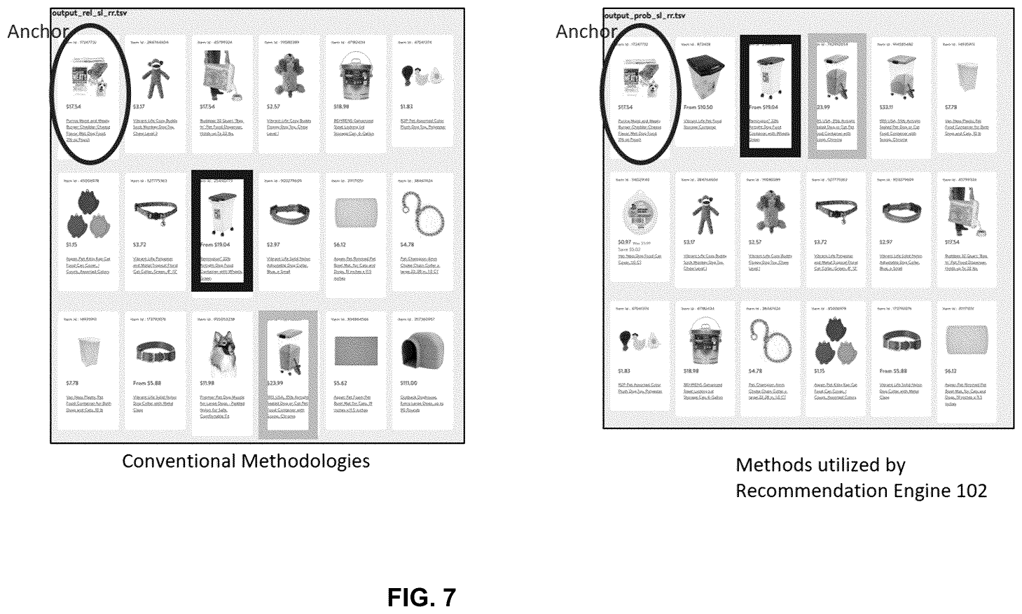

FIG. 7 illustrates a comparison of the visual representation of the prioritization of XP products of conventional methodologies and the methods utilized by recommendation engine 102. Using conventional methodologies that solely rely on a relevance score, it can be seen in FIG. 7 that XP products that the customer has a high affinity for are displayed lower and thus are not quickly or easily seen by the customer when using an e-commerce platform. In contrast, utilizing recommendation engine 102 results in XP products that the customer has a high affinity for being displayed at the top to be quickly and easily seen by the customer when using an e-commerce platform. This results in an increase likelihood of the customer purchasing the XP product and increasing the GMV of the customer for the retailer.

In some embodiments, affinity engine 304 is configured to utilize a model as follows to generate comparisons between XP products in the same journey:

$$Score ( i , j ) = {w}_{brand} \cdot ( {BrandAffinity}_{i} - {BrandAffinity}_{j} ) + {w}_{price} \cdot ( {PriceAffinity}_{i} - {PriceAffinity}_{j} ) + {w}_{producttype} \cdot ( {ProductTypeAffinity}_{i} - {ProductTypeAffinity}_{j} ) + {w}_{XPintent} \cdot ( {XPIntentAffinity}_{i} - {XPIntentAffinity}_{j} ) + {w}_{relevance} \cdot ( {RelevanceScore}_{i} - {RelevanceScore}_{j} )$$

Where W_{brand}, W_{price}, W_{producttype}, W_{XPintent}, and W_{relevance}, are the numerical weights corresponding to Brand affinity, Price affinity, Product type affinity, Customer journey-based XP intent affinity, and the relevance score, respectively. In some embodiments, score (i, j) represents the score for item i compared to item j, each being an XP product. BrandAffinityᵢ, PriceAffinityᵢ, ProductTypeAffinityᵢ, XPIntentAffinityᵢ, and RelevanceScoreᵢ denote the respective affinities and relevance score for item i. The subtraction in each term reflects the comparison between the features of item i and item j.

To optimize for customer interactions, the weights-W_{brand}, W_{price}, W_{producttype}, W_{XPintent}, and W_{relevance}—are adjusted or manipulated iteratively to maximize the score. The weights can be optimized based on items that customers engage with versus those that are not presented to the customer. Alternatively, these can be optimized based on a set of items that a customer has engaged with versus those that have not been engaged with. In some embodiments, affinity engine 304 utilizes the weights to compute the affinity score for each XP item, which is transmitted to product engine 306 to facilitate the re-ranking of XP products based on their predicted affinity to a customer. In some embodiments, the affinity score contributes to the prioritizing of the XP product only when the interactions for items i and j are different, allowing for the refining of the model based on instances where the predicted interactions need improvement. In some embodiments, affinity engine 304 is configured to generate an updated affinity score based on the iteratively manipulated weights.

Affinity engine 304 may generate an affinity score for each XP product based on the weights determined above and as follows:

$${OverallScore}_{item} = {w}_{brand} \cdot {BrandAffinity}_{item} + {w}_{price} \cdot {PriceAffinity}_{item} + {w}_{product type} \cdot {ProductTypeAffinity}_{item} + {w}_{XP intent} \cdot {XPIntentAffinity}_{item} + {w}_{relevance} \cdot {RelevanceScore}_{item}$$

In some embodiments, the model undergoes incremental training at a regularly set time frame, time period, or duration enabling it to continuously adapt and refine its ranking strategy based on the most recent customer interactions. This iterative process creates a dynamic feedback loop, enhancing the model's precision in personalization by incorporating up-to-date insights from customer behavior. As a result, the re-ranker becomes progressively more adept at aligning recommendations of XP products with evolving customer preferences and behaviors over time.

In some embodiments, affinity engine 304 is configured to evaluate the one or more models used to generate the affinity score. In assessing the effectiveness of the one or more models, a comprehensive evaluation strategy is employed. The evaluation focuses on the refinement and personalization of recommendations based on customer journey-centric cross-pollination intent. Key metrics such as Normalized Discounted Cumulative Gain (NDCG), Mean Average Precision (MAP), and Mean Reciprocal Rank (MRR) are shown below and are employed to gauge the model's ability to optimize XP product rankings, ensuring that personalized recommendations are not only contextually relevant but also strategically positioned within the customer's journey.

NDCG (Normalized Discounted Cumulative Gain):

$$NDCG @ k = \frac{DCG @ k}{IDCG @ k}$$

NDCG assesses the quality of a ranking for items by evaluating the prominence of relevant items within the top k positions of the list. The metric is normalized by the maximum achievable DCG score (IDCG@k) for the set of interacted items.

### MAP (Mean Average Precision):

$$MAP = \frac{1}{Total Items} {\sum }_{i = 1}^{Total Items} \frac{{AP}_{i}}{Total Relevant {Items}_{i}}$$

MAP calculates the average precision for each item in the set of interacted items and then averages these values over all items. It provides a comprehensive measure of the model's ranking performance, considering the precision at each position for relevant items.

### MRR (Mean Reciprocal Rank):

$$MRR = \frac{1}{Total Items} {\sum }_{i = 1}^{Total Items} \frac{1}{{Rank}_{i}}$$

MRR assesses the effectiveness of the model by measuring the reciprocal of the rank at which the first relevant item is found on average across all items. It emphasizes the position of the first relevant item in the ranking.

In some embodiments, product engine 306 is configured to display on a user interface an arrangement of the XP products based on the affinity score and prioritization received from affinity engine 304. For example, based on the affinity score and the prioritization, product engine 306 may display a first XP product at the top of a list or carousel of products. The first XP product may be indicated by affinity engine 304 as being a product the customer has a high likelihood of adding to their cart for purchasing. In some embodiments, product engine 306 causes a user interface to display the first XP product at a location proximate to products that are added to the cart.

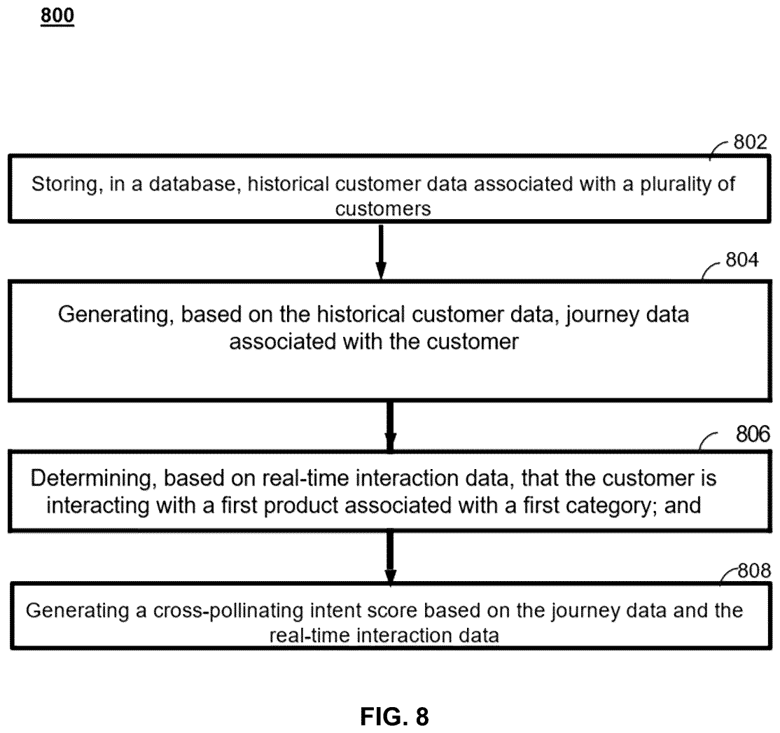

FIG. 8 is a flowchart illustrating an exemplary method for recommending products to a customer based on a customer's affinity. At operation 802, recommendation engine 102 may store, in a database, historical customer data associated with a plurality of customers. The historical customer data may include profile data and journey data. The journey data may be representative of one or more journeys associated with the customer. The historical customer data may include interaction data compiled based on the customer's interaction with an e-commerce platform. For example, the customer, via a user interface, may click, interact with, add to cart, view, or purchase one or more products. At operation 804, recommendation engine 102 may generate, based on the historical customer data, journey data associated with the customer. At operation 806, recommendation engine 102 may determine, based on the real-time interaction data, that the customer is interacting with a first product associated with a first category. The first category may be a category such as online grocery or general merchandise. At operation 808, recommendation engine may generate a cross-pollinating intent score based on the journey data and the real-time interaction data. The cross-pollinating intent score may be indicative of a likelihood that the customer purchases at least one product in a second category different than the first category. The at least one product may be associated with one or more journeys of the journey data. The at least one product may not be associated with the first category. In some embodiments, the first category is online grocery and the at least one product is associated with a second category different than the first category such as general merchandise. The at least one product may be product that the customer has a high likelihood to purchase.

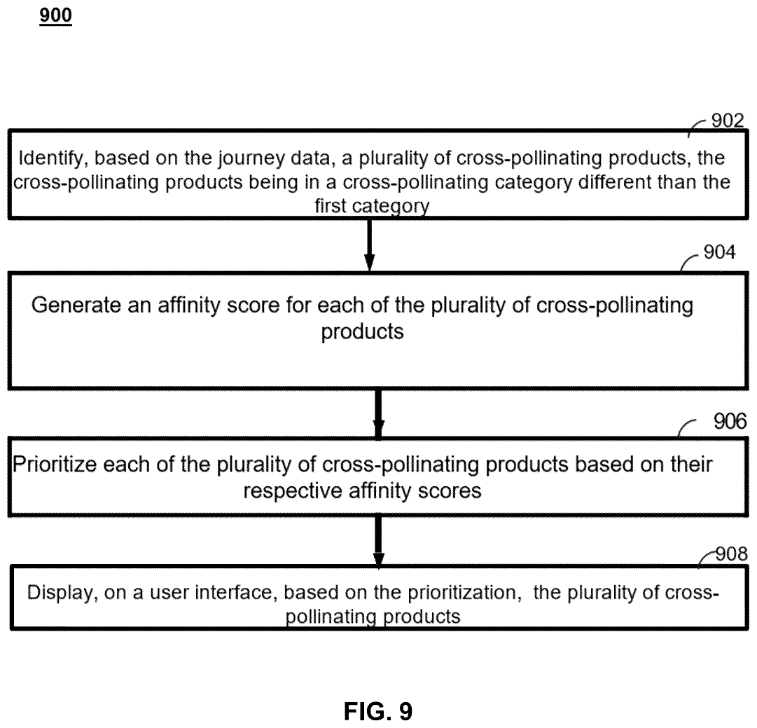

FIG. 9 is a flowchart illustrating an exemplary method for recommending products to a customer based on a customer's affinity. At operation 902, recommendation engine 102 may identify, based on the journey data, a plurality of cross-pollinating products, the cross-pollinating products being in a cross-pollinating category different than the first category. For example, the first category may be online grocery and the cross-pollinating category may be general merchandise. In some embodiments, the cross-pollinating category is associated with at least one journey from the journey data. For example, the customer may be associated with a new parent journey, which may be represented in the journey data. The cross-pollinating category may be baby care associated with the new parent journey. In some embodiments, the cross-pollinating product is diapers, bottles, onesies, or another baby care related product. At operation 904, recommendation engine 102 may generate an affinity score for each of the plurality of cross-pollinating products. For example, for each of the cross-pollinating products, recommendation engine 102 may generate an affinity score that indicates the customer's affinity to each of the cross-pollinating products. The affinity score may be based on one or more weights such as an affinity of the customer to specific prices, specific brands, specific product types, and/or specific products. In some embodiments, the one or more weights are based off the historical customer data. For example, the historical customer data may include interaction data and using one or more models, recommendation engine 102 may determine an affinity of the customer to specific brands, prices, product types, and/or products.

At operation 906, recommendation engine 102 may prioritize each of the plurality of cross-pollinating products based on their respective affinity scores. For example, recommendation engine 102 may be configured to present the plurality of cross-pollinating products in a specific arrangement to ensure that the customer selects and purchases a cross-pollinating product to increase the GMV associated with the customer. For example, for the customer on a new parent journey, recommendation engine 102 may prioritize a specific diaper due to the one or more weights. At operation 908, recommendation engine 102 may be configured to display, on a user interface, based on the prioritization, the plurality of cross-pollinating products in a specific arrangement. For example, recommendation engine 102 may be configured to cause a user interface to display the plurality of cross-pollinating products in a specific arrangement or order based on the affinity scores. In practice, recommendation engine 102 may cause a user interface to place a product having the highest affinity score in a location on the user interface that allows the customer to view the product without further interactions (e.g., presenting the product adjacent to the cart or at the top of a list or carousel of products).

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical customer data associated with a plurality of customers;
a computing device comprising at least one processor in communication with the database, the computing device being configured to:
generate, based on the historical customer data, journey data associated with the customer;
determine, based on real-time interaction data, that the customer is interacting with a first product associated with a first category; and
generate a cross-pollinating intent score based on the journey data and the real-time interaction data.

2. The system of claim 1, wherein the computing device is further configured to:
identify, based on the journey data, a plurality of cross-pollinating products, the cross-pollinating products being in a cross-pollinating category different than the first category;
generate an affinity score for each of the plurality of cross-pollinating products;
prioritize each of the plurality of cross-pollinating products based on their respective affinity scores; and
display, on a user interface, based on the prioritization, the plurality of cross-pollinating products in a specific arrangement.

3. The system of claim 2, wherein the affinity score is dependent on one or more of a brand affinity score, a product type affinity score, a price affinity score, and a relevance score.

4. The system of claim 2, wherein the affinity score is dependent the cross-pollinating intent score.

5. The system of claim 2, wherein the affinity score is generated by a machine learning model that is evaluated and refined.

6. The system of claim 5, wherein the machine learning model undergoes incremental training at a regularly set time frame to cause refinement of the machine learning model.

7. The system of claim 2, wherein the computing device is further configured to:
generate a comparison between two or more cross-pollinating products;
based on the comparison, iteratively manipulate one or more weights associated with the affinity score; and
generate an updated affinity score based on the manipulated one or more weights.

8. The system of claim 1, wherein the cross-pollinating intent score is a probability that the customer interacts with a second product associated with a second category different than the first category.

9. The system of claim 1 further comprising:
a user interface configured to display a plurality of cross-pollinating products in a prioritized arrangement.

10. The system of claim 1, wherein the historical customer data includes profile data associated with the journey data.

11. A method comprising:
storing, in a database, historical customer data associated with a plurality of customers;
generating, based on the historical customer data, journey data associated with the customer;
determining, based on real-time interaction data, that the customer is interacting with a first product associated with a first category; and
generating a cross-pollinating intent score based on the journey data and the real-time interaction data.

12. The method of claim 11 further comprising:
identifying, based on the journey data, a plurality of cross-pollinating products, the cross-pollinating products being in a cross-pollinating category different than the first category;
generating an affinity score for each of the plurality of cross-pollinating products;
prioritizing each of the plurality of cross-pollinating products based on their respective affinity scores; and
displaying, on a user interface, based on the prioritization, the plurality of cross-pollinating products in a specific arrangement.

13. The method of claim 12, wherein the affinity score is dependent on one or more of a brand affinity score, a product type affinity score, a price affinity score, and a relevance score.

14. The method of claim 12, wherein the affinity score is dependent the cross-pollinating intent score.

15. The method of claim 12, wherein the affinity score is generated by a machine learning model that is evaluated and refined.

16. The method of claim 15, wherein the machine learning model undergoes incremental training at a regularly set time frame to cause refinement of the machine learning model.

17. The method of claim 12, wherein the method further includes:
generating a comparison between two or more cross-pollinating products;
based on the comparison, iteratively manipulating one or more weights associated with the affinity score; and
generating an updated affinity score based on the manipulated one or more weights.

18. The method of claim 11, wherein the cross-pollinating intent score is a probability that the customer interacts with a second product associated with a second category different than the first category.

19. The method of claim 11 further comprising:
displaying, on a user interface, a plurality of cross-pollinating products in a prioritized arrangement.

20. A non-transitory computer readable medium having instructions stored thereon, wherein the instructions, when executed by at least one processor, cause at least one device to perform operations comprising:
storing, in a database, historical customer data associated with a plurality of customers;
generating, based on the historical customer data, journey data associated with the customer;
determining, based on real-time interaction data, that the customer is interacting with a first product associated with a first category; and
generating a cross-pollinating intent score based on the journey data and the real-time interaction data in a specific arrangement.
